(19) United States
(12) Patent Application Publication
(10) Pub. No.: US 2019/0010032 A1
(43) Pub. Date: Jan. 10, 2019

(54) LIFTING JACK

(71) Applicant: Phillip FARQUHARSON, Musswellbrook (AU)

(72) Inventor: Phillip FARQUHARSON, Musswellbrook (AU)

(21) Appl. No.: 16/027,295

(22) Filed: Jul. 4, 2018

(30) Foreign Application Priority Data
Jul. 4, 2017 (AU) 2017902613

(51) Int. Cl. B66F 3/38; B66F 3/26

(52) U.S. Cl. CPC B66F 3/38; B66F 2700/057; B66F 3/26

(57) ABSTRACT

The base section for a lifting jack includes upper and lower plates with complementary curved facing and engaging surfaces which allows the barrel of the lifting jack to pivot relative to the ground in use. In a typical lifting jack, the barrel is perpendicular to the ground in use. In the present invention, the base section allows the lifting assembly to pivot relative to the ground up to an angle of 15° from vertical in any direction from vertical.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a lifting jack, in particular a lifting jack with a barrel pivotable relative to its base.

### 2. Description of Related Art Including Information Disclosed Under 37 CFR 1.97 and 37 CFR 1.98.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a lifting jack comprising:
a lifting assembly having a barrel with a movable piston therein, and a rod mounted to the piston, and
a base section comprising an upper component to which the barrel is mounted and a lower component for engaging the ground, wherein the upper and lower components comprise complementary curved facing and engaging surfaces which allows for pivoting movement of the upper component relative to the lower component, thereby allowing the lifting assembly to tilt relative to the ground.

In a preferred embodiment, the complementary curved facing and engaging surfaces allows for rotational movement of the upper component relative to the lower component.

In another preferred embodiment, the upper and lower components are upper and lower plates, and the complementary curved facing and engaging surfaces comprise a convex surface in one of the upper and lower plates and a concave surface in the other of the upper and lower plates.

In another preferred embodiment, a lower end of the barrel is mounted to and extends perpendicularly upwardly from an upper surface of the upper plate.

In another preferred embodiment, the lower plate comprises a lower surface adapted to engage the ground in use.

In another preferred embodiment, the lower surface includes ground engaging means.

In another preferred embodiment, the complementary curved facing and engaging surfaces comprise a low friction means therebetween.

In another preferred embodiment, the base section comprises a retainer mounted to the lower plate and engaging the upper plate to prevent or substantially limit axial separation between the complementary curved facing and engaging surfaces.

In another preferred embodiment, the low friction means comprises one of ball bearings or low friction plastic material.

In another preferred embodiment, the complementary curved facing and engaging surfaces are shaped as a hinge joint with one surface being cylindrical and the other being a half hollow tubular surface which receives the cylindrical surface.

In another preferred embodiment, the base section includes limit stops to limit the pivoting movement of the upper component relative to the lower component.

In another preferred embodiment, the base section includes limit stops to limit the rotational movement of the upper component relative to the lower component.

In another preferred embodiment, the base section includes locking means for locking the orientation of the upper component relative to the lower component.

In another preferred embodiment, the locking means locks the upper component relative to the lower component such that the barrel extends vertically.

The present invention in another aspect provides a lifting jack having a barrel and a pivoting base for the barrel, wherein the base comprises an upper component to which the barrel is mounted and a lower component for engaging the ground, wherein the upper and lower components comprise complementary curved facing and engaging surfaces which allows for pivoting movement of the upper component relative to the lower component, thereby allowing the barrel to tilt relative to the ground.

The present invention in another aspect provides a pivoting base for retrofitting to a lifting jack, the pivoting base comprising an upper component to which the lifting jack is mounted and a lower component for engaging the ground, wherein the upper and lower components comprise complementary curved facing and engaging surfaces which allows for pivoting movement of the upper component relative to the lower component, thereby allowing the lifting jack to tilt relative to the ground.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a schematic front cross-section view of a lifting jack according to a preferred embodiment of the present invention.

FIG. 2 a top plan view of the base of the lifting jack.

FIG. 3A is a schematic view showing the use of a prior art lifting jack in a retracted position thereof.

FIG. 3B is a schematic view showing the use of a prior art lifting jack in an extended position thereof.

FIG. 3C is a schematic view showing the use of a lifting jack of the preferred embodiment in an extended position thereof.

FIG. 4 is a perspective view of a lifting jack with a tilting base according to another preferred embodiment.

### DETAILED DESCRIPTION OF THE INVENTION

It should be noted in the following description that like or the same reference numerals in different embodiments denote the same or similar features.

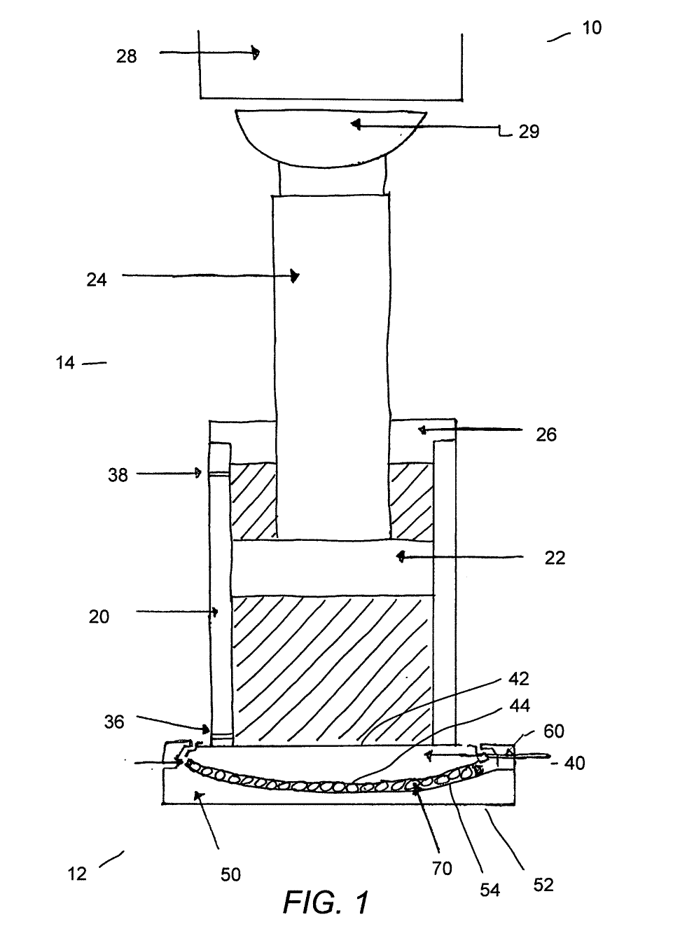

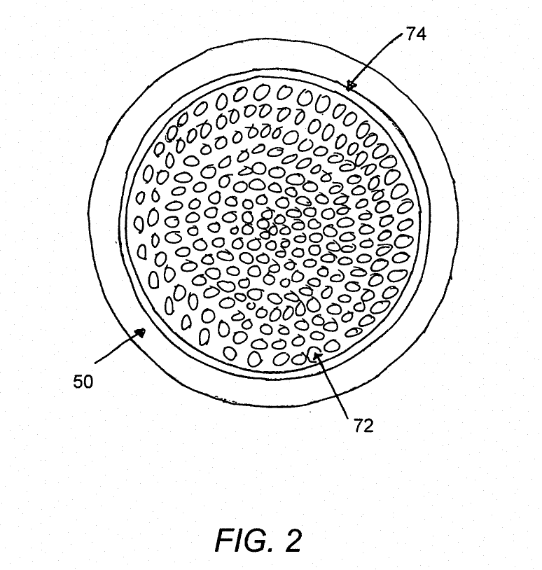

FIGS. 1 and 2 shows a lifting jack 10 according to a preferred embodiment of the present invention. The invention is described in relation to a hydraulic jack but is not limited thereto. The lifting jack 10 shows a specific example hydraulic mechanism but the invention is not limited to any specific mechanism or structure. The invention can be used for other types of lifting jacks including mechanical and pneumatic lifting jacks, and combination jack/stands.

The lifting jack 10 comprises a base section 12 and a lifting assembly 14.

The lifting assembly 14 as per typical lifting jacks includes a hollow barrel 20 with a piston 22 movable along an internal surface of the barrel. An elongate rod 24 extends upwardly from the piston 22, the rod 24 extending through an aperture in a top cap or gland closure 26 which closes an upper end of the barrel 20. An upper end of the rod 24 includes a saddle or jack point 28, and the example shown includes a pivot 29 between the jack point 28 and the upper end of the rod 24. In the example shown, the piston 22 in the barrel 20 forms chambers into which can be pumped a high-pressure oil via barrel side oil port 36 or low-pressure oil via rod side oil port 38.

The present invention primarily relates to the base section 12 which comprises upper and lower plates 40 and 50 with complementary curved facing and engaging surfaces 44 and 54 which allows the barrel 20 to pivot or tilt relative to the ground in use. In a typical lifting jack, the barrel is perpendicular to the ground in use. In the present invention, the base section 12 allows the lifting assembly 14 to pivot or tilt relative to the ground up to an angle of 15° from vertical in any direction from vertical. The preferred pivot angle range is up to 10° from vertical.

The upper plate 40 comprises a flat upper surface 42 and a convex lower surface 44. A lower end of the barrel 20 is mounted to and extends upwardly from the upper surface 42. The lower plate 50 comprises a flat lower surface 52 and a concave upper surface 54. The lower surface 52 is adapted to engage the ground in use and can include ground engaging means such as high friction rubber or plastic, or ground engaging formation such as spikes or a loop for ground spikes.

The complementary facing lower surface 44 and upper surface 54 comprise a low friction means 70 therebetween to allow relative lateral and/or rotational movement therebetween. The lateral movement between the complementary surfaces 44 and 54 results in the relative angle between the flat upper surface 42 and the flat lower surface 52 to be changeable, from being parallel to each other, to the flat upper surface 42 being angled relative to the flat lower surface 52 by an angle up to 15° relative to the horizontal in any direction. The base section 12 comprises a retainer 60 mounted to the lower plate 50 and engaging the upper plate 40. The retainer 60 prevents or substantially limits axial movement or separation between the complementary facing surfaces 44 and 54, but allows the lateral movement therebetween. The retainer 60 can also be used to limit the lateral movement between the upper plate 40 and the lower plate 50.

In the example shown, the low friction means 70 comprises ball bearings 72 retained thereon by an annular outer race 74. The low friction means 70 can be embodied in other forms such as low friction plastic or lubricant between the complementary facing surfaces 44 and 54. The low friction means 70 can also be omitted.

The shapes of the complementary facing surfaces 44 and 54 allows the upper plate 40 to move laterally or rotate relative to the lower plate 50. Alternatively, the shapes of the complementary facing surfaces 44 and 54 can be reversed with the lower surface 44 being concave and the upper surface 54 being convex.

With the barrel 20 mounted to the upper plate 40 and extending upwardly therefrom, the base section 12 allows the barrel 20 to tilt/pivot and/or rotate relative to the ground as engaged by the lower surface 52. The complementary facing surfaces 44 and 54 thus essentially function as a ball and socket joint for the barrel 20. The barrel 20 can tilt up to an angle of 15° from the vertical in the embodiment.

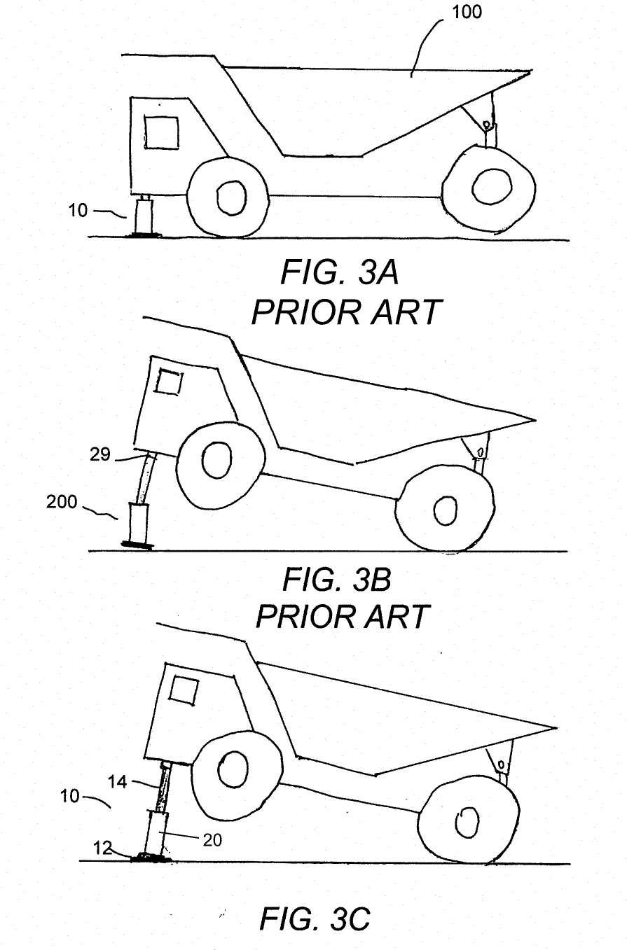

Referring to FIGS. 3A, 3B, and 3C, FIG. 3A shows a lifting jack 10 in a retracted position thereof positioned below a front end of a truck 100. FIG. 3B shows a prior art lifting jack 200 in an extended position thereof. The pivot 29 provides a pivoting top saddle to allow for different angles of machinery jacking points and changing angles as the vehicle is lifted. The prior art lifting jack 200 does not include the base section 12 and the jacking process causes side loading of the jack 200, rubbing/wearing or scuffing of the piston on the barrel and or rubbing/wearing or scuffing of the rod on the gland. This damage happens slowly over time with every lifting jack 200 and becomes expensive to repair as most components need to be replaced.

FIG. 3C shows the lifting jack 10 of the preferred embodiment. During the jacking process, the barrel 20 is able to tilt/pivot and/or rotate relative to the ground as engaged by the lower plate 50 and as jacking point 28 moves away from jack assembly as the jack extends. This addresses the above problem by providing the pivoting/rotating base section 12 to the bottom of the hydraulic jack.

The present invention in another aspect provides a pivoting base which can be retrofitted to a lifting jack. The pivoting base can comprise the upper and lower plates with the complementary facing surfaces 44 and 54. The upper plate for example can be shaped for mounting to the base of a prior art lifting jack, and the pivoting base will then provide the advantages of the present invention.

Although preferred embodiments of the present invention have been described, it will be apparent that modifications can be made to the described embodiments. For example, the complementary facing surfaces 44 and 54 can be shaped as a hinge joint with one surface being cylindrical and the other being a half hollow tubular surface which receives the cylindrical surface. These surfaces will provide a tilting movement but not rotational movement.

The base can also include limit stops to limit angular movement and/or rotation movement as desired.

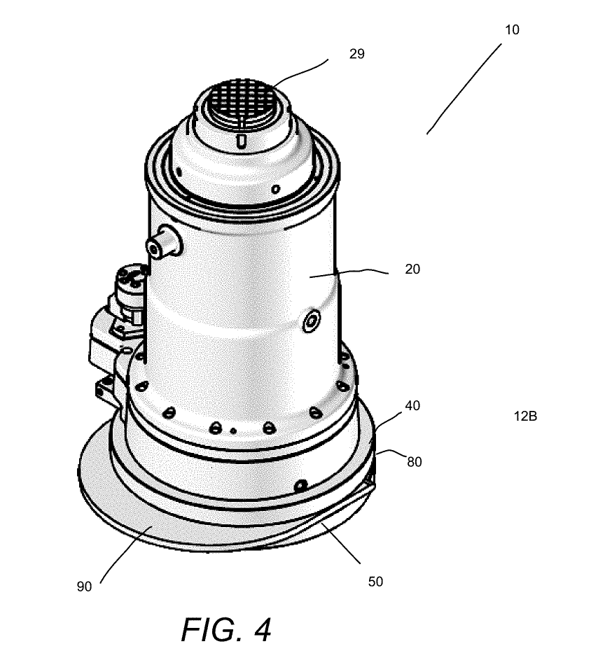

The base section 12 can also include a locking means to lock the orientation of the upper plate 40 relative to the lower plate 50 as desired. One example of the locking means is shown in FIG. 4, where the upper plate 40 and the lower plate 50 comprise a peripheral recess 80 therebetween. A locking plate 90 is then insertable into the recess 80 to lock the orientation of the upper plate 40 relative to the lower plate 50. The locking plate 90 is generally a C-shaped plate and is inserted to be wedged into the recess 80. In this embodiment, the locking plate 90 maintains the upper plate 40 and the lower plate 50 in position to have the barrel 20 extending vertically and avoid any tilting, pivoting or rotational movement thereof. The locking means for example can be used where multiple jacks 10 are used to lift a vehicle to avoid the jacks tilting.

The embodiment thus provides a lifting jack with a tilting base.

1. A lifting jack comprising:
a lifting assembly being comprised of a barrel with a movable piston therein, and a rod mounted to the piston; and
a base section being comprised of an upper component to which the barrel is mounted, and a lower component for engaging the ground,
wherein the upper and lower components comprise complementary curved facing and engaging surfaces so as to allow pivoting movement of the upper component relative to the lower component, said lifting assembly to-tilt being tilted relative to the ground.

2. The lifting jack of claim 1 wherein the complementary curved facing and engaging surfaces allows for rotational movement of the upper component relative to the lower component.

3. The lifting jack of claim 1 wherein the upper and lower components are comprised of upper and lower plates, and wherein the complementary curved facing and engaging surfaces comprise a convex surface in one of the upper and lower plates and a concave surface in the other of the upper and lower plates.

4. The lifting jack of claim 3 wherein a lower end of the barrel is mounted to and extends perpendicularly upwardly from an upper surface of the upper plate.

5. The lifting jack of claim 3 wherein the lower plate comprises a lower surface so as to engage the ground in use.

6. The lifting jack of claim 5 wherein the lower surface comprises ground engaging means.

7. The lifting jack of claim 3 wherein the complementary curved facing and engaging surfaces comprise a low friction means therebetween.

8. The lifting jack of claim 3 wherein the base section comprises a retainer mounted to the lower plate and engaging the upper plate to prevent or substantially limit axial separation between the complementary curved facing and engaging surfaces.

9. The lifting jack of claim 7 wherein the low friction means comprises one of ball bearings or low friction plastic material.

10. The lifting jack of claim 1 wherein the complementary curved facing and engaging surfaces are shaped as a hinge joint with one surface being cylindrical and the other being a half hollow tubular surface which receives the cylindrical surface.

11. The lifting jack of claim 1 wherein the base section comprises limit stops to limit the pivoting movement of the upper component relative to the lower component.

12. The lifting jack of claim 2 wherein the base section comprises limit stops to limit the rotational movement of the upper component relative to the lower component.

13. The lifting jack of claim 1 wherein the base section comprises means for locking the orientation of the upper component relative to the lower component.

14. The lifting jack of claim 13 wherein the locking means locks the upper component relative to the lower component such that the barrel extends vertically.

15. A lifting jack comprising: a barrel and a pivoting base for the barrel, wherein the base comprises an upper component to which the barrel is mounted and a lower component for engaging the ground, wherein the upper and lower components comprise complementary curved facing and engaging surfaces which allows for pivoting movement of the upper component relative to the lower component, thereby allowing the barrel to tilt relative to the ground.

16. A pivoting base for retrofitting to a lifting jack, comprising an upper component to which the lifting jack is mounted and a lower component for engaging the ground, wherein the upper and lower components comprise complementary curved facing and engaging surfaces which allows for pivoting movement of the upper component relative to the lower component, thereby allowing the lifting jack to tilt relative to the ground.
